(19) United States
(12) Patent Application Publication
(10) Pub. No.: US 2006/0129500 A1
(43) Pub. Date: Jun. 15, 2006

(54) Method for managing pay parking spaces using electronic parking tickets

(76) Inventors: Damien Mandy, Fontain (FR); Thierry Mougin, Saint Vit (FR)

Correspondence Address: SOFER & HAROUN LLP., 317 MADISON AVENUE, SUITE 910, NEW YORK, NY, 10017, US

(21) Appl. No.: 10/536,045

(22) PCT Filed: Dec. 11, 2003
(86) PCT No.: PCT/FR03/03673

§ 371 Date: Dec. 8, 2005

(30) Foreign Application Priority Data
Dec. 12, 2002 (FR) 02/15881

(51) Int. Cl. G06Q 99/00

(52) U.S. Cl. 705/65

(57) ABSTRACT

The invention concerns a method for managing pay parking spaces of the type using a terminal (1, 10) providing, against payment, a parking ticket (2, 20, 21) to a user. The ticket bears an authorized parking time limit corresponding to the payment and is designed to be left in the user's vehicle (3) to enable control thereof by an enforcement officer. The ticket is an electronic ticket (2, 20, 21) such as a transponder and the enforcement officer is equipped with a portable reader (4) enabling the data recorded in the electronic ticket (2, 20, 21) to be controlled by radio signal.

The present invention concerns a method for managing pay parking spaces, in particular on-road parking spaces, using a parking ticket in the form of a transponder.

Using payment terminals such as parking ticket dispensers to manage pay parking spaces, either on-road parking spaces or spaces in so-called “open” car parks (as opposed to closed car parks or multistorey car parks with entry and exit barriers) is currently well known in the art. The motorist, having parked his vehicle in a pay parking space, makes his way to a nearby parking ticket dispenser. He pays a certain sum of money corresponding to the time for which he wishes to park his vehicle in the occupied parking space. In exchange for this payment, the parking ticket dispenser prints out a ticket showing the parking expiry date and time, and possibly the price paid by the user. The user then places this ticket visibly on the dashboard of his vehicle to enable visual inspection thereof by enforcement officers.

The parking ticket dispensers deliver paper parking tickets on which parking information is printed. Regardless of the printing technique selected (thermal printing, dot matrix printing, etc.), the printing of these paper tickets has certain drawbacks.

First of all, there is the possibility of fraud, for example by printing counterfeit tickets using stolen parking ticket dispensers or printers, which makes paper parking tickets relatively insecure.

Moreover, the data printed on a parking ticket is static, in the sense that it cannot evolve. Motorists increasingly wish the parking fee to be adaptable to the time for which they actually park, and to this end for it to be possible for the parking time initially paid for at the payment terminal to be extended or reduced. This modification of the parking time implies being able to make the information initially printed obsolete.

Note also that the life span of paper parking tickets is limited. The method of printing, in particular in the case of thermal printing, necessitates the use of treated paper, with treatments that are incompatible with long exposure to heat and light, for example when tickets are placed behind the windshield of vehicles parked for long periods (several weeks).

Moreover, the principle of issuing paper parking tickets tends to increase the operating costs of the terminals, for two reasons, namely the unit cost of each printed ticket and printer maintenance costs, since the printers for printing paper parking tickets must include mechanisms with gears (for feeding the paper) and print heads. These printer components are subject to wear and thus necessitate considerable preventive maintenance (cleaning, adjustment) and corrective maintenance (replacement).

The present invention therefore proposes to remedy the above drawbacks by replacing the printed paper parking ticket with an electronic ticket (card, token, etc.) that uses a contactless technology to communicate with reading/writing means.

The method of the invention for managing pay parking spaces is of the type using a terminal authorizing a user to park by means of a ticket that carries parking data, such as an authorized parking expiry time, and is intended to be left in the vehicle of the user to enable checking thereof by an enforcement officer.

According to the invention a method of this kind is characterized in that said ticket is an electronic ticket of the transponder type, the enforcement officer is provided with a portable reader device for checking the data recorded in said ticket by means of a radio signal.

According to another feature of the method of the invention said electronic ticket is a passive transponder using inductive coupling to receive or transmit data, in particular in accordance with the contactless technologies defined in the standard ISO 14443 or ISO 15593.

According to another feature of the method of the present invention, the payment terminal creates the electronic ticket and encodes it with appropriate parking data corresponding to the payment made by the user.

According to another feature of the method of the present invention, the payment terminal encodes appropriate parking data on an electronic ticket presented by the user.

This kind of ticket, taking the form of an ISO (54 mm×85 mm) plasticized card, for example, is then in the permanent possession of the motorist, who merely updates it each time he parks near a payment terminal.

Because of this, the parking terminals, such as parking ticket dispensers, adapted to use the above kind of electronic ticket are provided either with a peripheral for issuing and encoding tickets or with a peripheral for merely encoding tickets. Note that a ticket dispenser adapted to create electronic tickets will also be adapted merely to encode an electronic pre-existing parking ticket presented by the motorist.

Ticket dispensers that do not issue tickets have the advantage of being very simple and therefore of low cost. An encoding peripheral necessitates reduced preventive and corrective maintenance compared to an issuing and encoding peripheral because, unlike the latter, it includes no moving parts (gears, etc.) or parts subject to wear.

According to another feature of the method of the present invention, said ticket includes personal data relating to the user which is taken into account by the terminal to calculate the cost of the parking time requested by the user.

According to another feature of the method of the present invention, the electronic ticket includes an electronic circuit having appropriate means, such as E2PROM memories, allowing multiple reuse and rewriting of said electronic ticket, all parking data being stored in sequence or only the latest parking data being stored, in which case previous data is erased.

According to another feature of the method of the present invention, the terminal takes account of the history of the parking data present on the electronic ticket presented by the user to calculate the cost of the parking time requested by the user.

According to another feature of the method of the present invention, said electronic ticket is intended to be placed in a holder stuck to the windshield or to one of the side windows of the parked vehicle, and in particular according to the capacities of the control device used and the characteristics of the windows of the vehicle.

According to another feature of the method of the present invention, the portable reader device used by the enforcement officer to check the data recorded in the ticket by means of a radio signal also has functions for printing out fines or for sending parking data to a remote dedicated server over a mobile telephone network of any type (GSM, CDMA, TDMA, AMPS, DAMPS, GPRS, UMTS).

According to another feature of the method of the present invention, the parking data encoded in the parking ticket includes the parking expiry date and time and the means of payment used.

Accordingly, the data encoded on the parking ticket includes the data that is customarily printed on paper parking tickets such as the parking expiry date and time, as well as more precise parking data such as the means of payment used, which data is not printed on paper tickets because of their limited area.

According to another feature of the method of the present invention, the operations of reading and writing the electronic ticket are protected either by security mechanisms, and in particular authentication mechanisms, or by communication encryption mechanisms.

Thus parking data stored in the parking ticket can be signed, using an appropriate encryption algorithm, so that the control device can check its integrity and authenticity.

According to another feature of the method of the present invention, said electronic parking ticket may be presented to said terminal again before the authorized parking expiry time in order for said authorized parking expiry time to be extended or to be brought forward to the time of presentation of the ticket to the terminal, these modifications of the parking time previously paid for respectively giving rise to a further payment or to a refund for unused parking time.

In this case, the ticket may include a storage area for unused time for subsequent use (in the event of a refund, for example).

This area can be used to credit the ticket with time to be used for parking, for example as a function of payments already made (loyalty schemes) or by third parties who have purchased credit rights (tradespersons, etc.).

By updating the parking ticket, the encoded data continues to conform to the amount or amounts actually paid for parking.

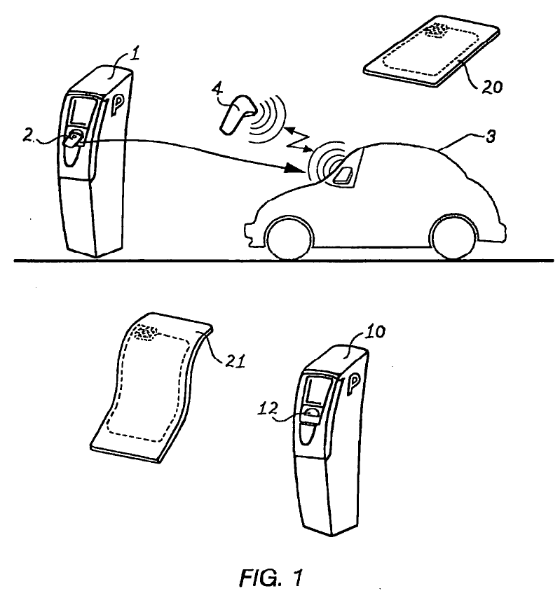

Objects, aspects and advantages of the present invention will be better understood from the description given hereinafter, by way of non-limiting example, of one embodiment of the invention, which description refers to the appended drawings, in which FIG. 1 is a diagrammatic view of a pay parking management system using a method of the invention.

FIG. 1, in which only the components necessary for understanding the invention are shown, represents two payment terminals for parking spaces belonging to an installed base of pay terminals distributed across a town.

In the present example the terminals 1 and 10 can either issue or recharge parking tickets. Parking ticket dispensers of the above kind are installed at regular intervals along the pavement alongside pay parking spaces. When a motorist wishes to leave his vehicle 3 parked in one of these spaces, he makes his way to a parking ticket dispenser, where he pays a required amount or a certain sum of money for a required parking time, by means of coins, a payment card, banknotes or any other payment means.

The right to park having been paid for, the motorist has 20 a certain authorized parking time.

According to the invention, this authorized parking time is encoded in an electronic parking ticket 2 of the transponder type. The term “transponder”, signifying transmitter/responder, will be used herein in a generic manner to describe any “contactless” electronic circuit capable of responding to a radio signal emitted by a “reader” device. A transponder of the above kind generally comprises an electronic chip including a microprocessor and a radio-frequency interface connected to an antenna.

For example, a transponder 2 of the above kind is either issued in the form of a ticket 21 by the ticket dispenser 1, which is specifically adapted for this purpose, or already in the possession of the motorist, for example in the form of a smart card 20 to the ISO format (54 mm×85 mm), the motorist merely loading new parking data from the terminal 1 or 10 in the latter case.

Note that the ticket dispenser 1 adapted to create electronic tickets is also adapted only to encode a pre-existing electronic parking ticket presented by a motorist.

To this end the terminal 1 is provided with an appropriate man/machine interface implemented in the terminal, thus enabling the motorist, when effecting his payment, to choose either to issue and encode a ticket or merely to encode a pre-existing card. Encouragement to use a pre-existing card could be implemented through an appropriate charging structure, issuing an electronic ticket being specifically invoiced, for example.

The terminal 10 has no means of issuing parking tickets, and merely encodes data on a pre-existing card 20 in the possession of the motorist, so that the card becomes the parking ticket authorizing parking of the vehicle 3.

If a parking card 20 of the above type is used, it is important for it to include an electronic circuit provided with appropriate means, such as E2PROM, enabling multiple reuse and rewriting of the electronic ticket, all parking data being stored in sequence, or only the latest parking data being stored, in which case previous parking data is deleted.

Note that the terminal can take account of the parking data history present on the electronic ticket presented by the user to calculate the cost of the parking time requested by the user. This history, or just the last parking transaction, may be printed out from any terminal on a paper ticket in order to render the information it contains visible to the motorist, for example if contesting a parking fine.

In contrast, the ticket 21 issued by the terminal 1 may be of the disposable single-use type 10.

Given the lower cost of the terminals 10 compared to the terminals 1, because of the absence of means for issuing electronic tickets, it is possible to envisage, as shown here, that the installed base of ticket dispensers for a given town combines ticket dispensers of the same type as the ticket dispenser 1, i.e. electronic parking ticket issuing and encoding dispensers, and ticket dispensers of the same type as the ticket dispenser 10, i.e. electronic parking ticket encoding dispensers, the latter amounting to two thirds of the installed base, for example. Of course, the present invention is not limited to this embodiment, and relates also to an installed base consisting entirely of ticket dispensers of the same type as the ticket dispenser 1 or consisting entirely of ticket dispensers of the same type as the ticket dispenser 10.

Once the parking data has been encoded on his electronic ticket 2, the motorist has only to place the electronic parking ticket behind the windshield of his vehicle 3. The electronic ticket may be placed in a holder stuck to the windshield or to one of the side windows of the parked vehicle 3, depending in particular on the capabilities of the enforcement device used and the characteristics of the windows of the vehicle.

The parking enforcement officer therefore has only to offer up his portable checking device 4, which reads the parking information carried by the card 2 using the appropriate contactless technology and deduces if the vehicle is legally parked or not. The device 4 is used to read through the windshield all of the parking data relating to the parking transaction stored in the parking ticket 2, in order to verify its integrity, authenticity and validity.

The tickets issued by the terminal 1 are preferably tickets with a card body 10 and dimensions that conform to the ISO format (54 mm×85 mm), for example. Obviously, the invention is not limited to this format and applies to all formats, and in particular to the Edmonson format (67 mm×30 mm).

The above kind of ticket consists of an electronic module disposed in a sheet of paper of appropriate thickness sandwiched between two protective coating layers.

The electronic module consists of an integrated circuit or chip and an antenna. The integrated circuit includes a radio-frequency (RF) portion, memories, in particular E2PROM, storing the data forming part of the application concerned (such as the authorized parking expiry time) and logic functions necessary for producing information to be issued and processing information received.

One function of the integrated circuit, in the case of a passive transponder 25, i.e. one with no power source of its own, is to provide a remote power feed, i.e. to rectify an electromagnetic signal at a given frequency (for example 13.56 MHz) transmitted by the base station (ticket dispenser or enforcement officer's portable checking device) writing or reading data contained in said ticket and received by means of the antenna, to supply energy to power the integrated circuit. The integrated circuit also has the function of receiving and/or transmitting information by modulation of the electromagnetic signal used as carrier.

The manufacture of card transponder tickets of the above kind is described in the patent application FR2796183, for example.

Of course the invention is not limited to a particular contactless identification technology, but concerns all contactless identification technologies that might be used (as opposed to an ohmic connection necessitating physical contact between two conductive surfaces), and in particular inductive technologies (for example as defined in the ISO standards 14443 “Contactless Integrated Circuit Cards—Proximity Cards” (or PICC) and ISO 15693 “Contactless Integrated Circuit Cards—Vicinity Cards” (or VICC), capacitive technologies (see ISO 10536), microwave or radio-frequency technologies (ISO/IEC 18000; ETSI 300 440, etc.) or infrared technologies. Obviously, the present invention is not limited to the use of parking tickets or cards having a flat rectangular body. The invention applies to any type of transponder, i.e. a transponder able to respond to a radio signal emitted by a reader device, regardless of the shape thereof.

According to the invention, the ticket dispensers 1 or 10 conventionally comprise a certain number of particular components inherent to such devices, in particular display and data entry units, such as a screen and a keypad, and payment means comprising a card reader and/or a coin handling system, etc. These devices are also equipped with contactless encoding means suited to the technology of the transponder 2. They therefore include a cavity 12 in which the card 20 may be placed and in the vicinity of which is an antenna controlled by an appropriate electronic circuit. The ticket dispenser 1 also includes means for issuing contactless tickets. All the above means are known in the art and will not be described in more detail.

The motorist therefore effects a parking transaction in the conventional way by inserting coins or by debiting a payment card an amount that corresponds to the required parking time. The user validates his transaction and then presents a contactless technology electronic card or token 20 in order to receive parking data by inserting it into the orifice 12 provided for this purpose on the terminal. If he is using the terminal 1, he can also obtain a specific contactless ticket 21.

He then places the parking ticket 20 or 21 in a holder stuck to the windshield of his vehicle 3. The parking ticket placed there can be checked by an electronic device 4.

Obviously the invention is not limited to the embodiments described, which have been presented by way of non-limiting example only.

Thus the parking data stored in the electronic parking ticket 20 may be signed using an appropriate encryption algorithm for the checking device to be able to check its integrity and authenticity.

The electronic parking ticket may be presented to the payment terminal 1 or 10 again during the current parking period so that the latter can be extended or cut short. This modification of the parking time previously paid for gives rise either to a further payment or to a refund corresponding to the unused parking time, respectively. By updating the parking ticket, the encoded data remains consistent with the amount or amounts actually paid for parking.

Thus the parking data that may be encoded on the electronic parking ticket includes the data usually printed on paper parking tickets, such as the parking expiry date and time, but also more precise parking data such as the means of payment used, which data is not printed on paper tickets because of their limited area.

The parking ticket is checked by means of an electronic reader device that may also be equipped with functions for printing out fines or sending parking data to a dedicated remote server via a mobile telephone network of any type (GSM, CDMA, TDMA, AMPS, D-AMPS).

Thus, in another embodiment, the electronic parking ticket 20 contains the profile of the motorist, i.e. his parking rights (resident, subscriber, etc.). If it is presented at the beginning of the transaction, it enables the terminal 1 to take account of the parking rights of the motorist, in particular the appropriate charging structure.

Thus, in another embodiment, the parking ticket 2 is not presented by the motorist at the end of parking for updating but issued by the ticket dispenser 1 with the data relating to the parking transaction.

Thus, in another embodiment, the parking ticket 2 is presented to the ticket dispenser 1 a second time for the transaction to be extended or cut short. In both cases (extending or cutting short the transaction), the motorist must insert payment means to pay for more parking time or to recover (on a payment card) an amount corresponding to the unused parking time.

Thanks to the use of a contactless technology in the case of long-term parking, the ticket may remain for several weeks in a vehicle without this leading to any physical deterioration of the support and therefore of the parking data to be verified.

1. Method for managing pay parking spaces of the type using a terminal authorizing a user to park in return for payment by means of an electronic ticket of the transponder type that carries parking data, such as an authorized parking expiry time, and is intended to be left in the vehicle of the user to enable checking thereof by an enforcement officer, said method comprising the steps of:
providing the enforcement officer with a portable reader device for checking the data recorded in said electronic ticket by means of a radio signal; and
said payment terminal either creating said electronic ticket and encoding it with parking data or encoding parking data on said electronic ticket presented by said user.

2. Method according to claim 1, wherein said electronic ticket is a passive transponder using inductive coupling to receive or transmit data, in particular in accordance with the contactless technologies defined in either standard ISO 14443 or ISO 15593.

3. Method according to claim 1 wherein said ticket includes personal data relating to the user which is taken into account by the terminal to calculate the cost of the parking time requested by the user.

4. Method according to claim 1, wherein the electronic ticket includes an electronic circuit having appropriate means, such as E2PROM memories, allowing multiple reuse and rewriting of said electronic ticket, all parking data being stored in sequence or only the latest parking data being stored, in which case previous data is erased.

5. Method according to claim 3, wherein the terminal takes account of the history of the parking data present on the electronic ticket presented by the user to calculate the cost of the parking time requested by the user.

6. Method according to claim 1, wherein said electronic ticket is intended to be placed in a holder stuck to the windshield or to one of the side windows of the parked vehicle.

7. Method according to claim 1, wherein said portable reader device used by said enforcement officer to check the data recorded in said ticket by means of a radio signal also has functions for printing out fines or for sending parking data to a remote dedicated server over a mobile telephone network.

8. Method according to claim 1, wherein the parking data encoded in the parking ticket includes the parking expiry date and time and the means of payment used.

9. Method according to any claim 1, wherein the operations of reading and writing the electronic ticket are protected either by security mechanisms, and in particular authentication mechanisms, or by communication encryption mechanisms.

10. Method according to claim 1, wherein said electronic parking ticket may be presented to said terminal again before the authorized parking expiry time in order for said authorized parking expiry time to be extended or to be brought forward to the time of presentation of the ticket to the terminal, these modifications of the parking time previously paid for respectively giving rise to a further payment or to a refund for unused parking time.

11. Method according to claim 1, wherein the ticket includes an unused parking time storage area that can be credited by the parking terminal or by terminals adapted to credit this time.
